(19) United States
(12) Patent Application Publication
(10) Pub. No.: US 2024/0005950 A1
(43) Pub. Date: Jan. 4, 2024

(54) Phonograph Record Player with Speaker

(71) Applicant: Innovative Technology Electronics, LLC, Denver, CO (US)

(72) Inventors: Jordan Gregory Rapp, Denver, CO (US); Byron Andrew Hu, Los Altos Hills, CA (US); Donald Louis Inmon II, Carmel, IN (US); Aaron Todd Fournier, Salt Lake City, UT (US)

(21) Appl. No.: 17/940,489

(22) Filed: Sep. 8, 2022

Related U.S. Application Data
(60) Provisional application No. 63/357,260, filed on Jun. 30, 2022.

(51) Int. Cl. G11B 3/61; H04R 1/02; H04R 1/40; H04R 3/12

(52) U.S. Cl. CPC G11B 3/61; H04R 1/025; H04R 1/403; H04R 3/12; H04R 1/2834

(57) ABSTRACT

A phonograph record player including a speaker enclosure within the record player that is mechanically insulated from the phonograph components to reduce vibrations from the speakers to the phonograph components. One or more coupling mechanisms are used that absorb, reduce, and/or minimize vibrations generated by components coupled to a secondary housing, such as speakers, from being transmitted to a primary housing that includes a turntable.

### CROSS-REFERENCE TO RELATED PATENT APPLICATION

The present application claims the benefit of and priority to U.S. Provisional Application No. 63/357,260, filed on Jun. 30, 2022, which is incorporated herein by reference in its entirety.

### BACKGROUND OF THE INVENTION

This disclosure pertains to phonograph record players, such as all-in-one record players that include phonograph components for reading and reproducing sounds from records (e.g., vinyl records), speakers for reproducing the sound, and all ancillary electronic components combined into a single all-in-one housing. One limitation of such record players is the ability to improve sound performance, power, and sound volume without causing disruptions to the reading of vinyl records through vibrations that lead to skipping and/or damage to the vinyl records.

A standard mechanical design for record players includes attaching speaker drivers directly to the main enclosure of the record player itself, whether it be plastic, wood, or other materials. Due to this direct attachment (e.g., via adhesives or fasteners), vibrations from the speaker drivers may translate through the fasteners to the main enclosure body material, and thus to the tonearm, cartridge, and needle used to read the grooves of the record. These vibrations cause the needle to move in all directions and can cause unwanted skipping and damage to both vinyl records and the record player.

To improve the sound performance, power, and volume as mentioned above, various embodiments in this disclosure vibrationally-isolate the speaker drivers inside the main record player enclosure through a mechanical system that reduces vibrations traveling from the speaker drivers to the phonograph components.

### SUMMARY OF THE INVENTION

One embodiment of the invention relates to a phonograph record player including a primary housing formed from a first material, a turntable coupled to the primary housing, the turntable configured to receive a record and rotate with respect to the primary housing, a stylus configured to interface with the record and generate a first electric signal representative of sound, a spring, a bushing formed from a second material having a lower number on the durometer scale than the first material, a secondary housing coupled to the primary housing such that the primary housing and the secondary housing interface via the bushing and the spring, and a speaker coupled to and within the secondary housing, the speaker configured to receive a second electric signal and generate sound based on the second electric signal.

In various embodiments, the second electric signal is the first electric signal. In various embodiments, the primary housing defines an internal storage volume, and the speaker is at least partially located within the internal storage volume.

In various embodiments, the bushing extends within the spring. In various embodiments, bushing defines an internal cavity receiving a projection extending from the primary housing.

In various embodiments, the bushing extends within a helical profile of the spring. In various embodiments, the spring is rigidly coupled to the secondary housing. In various embodiments, the bushing is formed from a material including rubber.

In various embodiments, the spring includes a first spring and the bushing includes a first bushing, and the phonograph record player includes a plurality of couplers that couple the secondary housing and the primary housing. The plurality of couplers each include a spring and a bushing, and a first coupler of the plurality of couplers includes the first spring and the first bushing. The secondary housing rests on at least four couplers of the plurality of couplers when the phonograph record player is playing a record.

Another embodiment of the invention relates to a phonograph record player including a primary housing defining an internal storage volume, a turntable coupled to the primary housing, the turntable configured to receive a record and rotate with respect to the primary housing, a stylus configured to interface with the record and generate a first electric signal representative of sound, a secondary housing coupled to the primary housing within the internal storage volume, a speaker coupled to and within the secondary housing, the speaker configured to receive an electric signal and generate sound based on the electric signal, and a first bushing that interfaces with the primary housing and the secondary housing such that the primary housing supports the secondary housing via the first bushing. The first bushing is selected from a group consisting of a first spring, a material formed from rubber, and a material formed from a foam.

In various embodiments, the phonograph record player includes a fastener coupling the secondary housing to the primary housing, and a second bushing that interfaces with the fastener and the secondary housing such that the fastener is vibrationally-insulated from the secondary housing via the second bushing. In various embodiments, the phonograph record player includes a projection that extends laterally from the secondary housing, the projection defining an internal opening that receives the second bushing. In various embodiments, the fastener is formed from a first material, and the second bushing is formed from a second material having a lower number on the durometer scale than the first material.

In various embodiments, the second bushing is formed from a material selected from a group consisting of rubber and foam. In various embodiments, the phonograph record player includes a projection that extends laterally from the secondary housing, the projection defining an internal opening that receives the second bushing. In various embodiments, the phonograph record player includes a plurality of lower bushings including the first bushing, the plurality of lower bushings interfacing with the primary housing and the secondary housing such that the primary housing supports the secondary housing via the plurality of lower bushings. In various embodiments, the plurality of lower bushings are arranged around a periphery of the secondary housing.

In various embodiments, the primary housing defines an internal storage volume, wherein the speaker is at least partially located within the internal storage volume. In various embodiments, the phonograph record player includes a support plate coupled to the primary housing, the support plate supporting the turntable, the support plate including a plurality of apertures through which the speaker projects the sound.

Another embodiment of the invention relates to a phonograph record player including a primary housing formed from a first material, a turntable coupled to the primary housing, the turntable configured to receive a record and rotate with respect to the primary housing, a stylus configured to interface with the record and generate a first electric signal representative of sound, a first secondary housing, a first speaker coupled to and within the first secondary housing, the first speaker configured to receive an electric signal and generate sound based on the electric signal, a first bushing that interfaces with the primary housing and the first secondary housing such that the primary housing supports the first secondary housing via the first bushing, a second secondary housing, a second speaker coupled to and within the second secondary housing, the second speaker configured to receive an electric signal and generate sound based on the electric signal, and a second bushing that interfaces with the primary housing and the second secondary housing such that the primary housing supports the second secondary housing via the second bushing.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a phonograph record player, according to an exemplary embodiment.

FIG. 2 is a schematic view of a portion of the phonograph record player of FIG. 1, according to an exemplary embodiment.

FIG. 3 is a perspective view of a phonograph record player, according to another exemplary embodiment.

FIG. 4 is an exploded perspective view of a portion of the phonograph record player of FIG. 3, according to an exemplary embodiment.

FIG. 5 is a perspective view of a portion of the phonograph record player of FIG. 3, according to an exemplary embodiment.

FIG. 6 is an exploded perspective view of a portion of the phonograph record player of FIG. 3, according to an exemplary embodiment.

FIG. 7 is an exploded perspective view of a portion of the phonograph record player of FIG. 3, according to an exemplary embodiment.

FIG. 8 is a perspective view of a phonograph record player, according to another exemplary embodiment.

### DETAILED DESCRIPTION

Referring generally to the figures, various embodiments of a phonograph record player with one or more speakers are shown. Phonograph record players are used to play records, such as vinyl records. Typically, a phonograph record player includes a turntable, a tonearm, and a stylus or needle coupled to the tonearm. When a record is placed on the turntable and rotated, the stylus is placed within a groove on the record to play the sound recorded on the record. External vibrations that are exerted on the turntable and/or the tonearm can cause the interface between the stylus and the groove to produce loud and/or undesirable sounds.

Applicant has developed an innovative design to incorporate one or more speakers within a phonograph record player such that vibrations from the speakers are insulated from the stylus and record. For example, the interface between the housing of the phonograph record player and the housing of the speaker includes a spring and/or a vibration-absorbing element, such as rubber. As a result, vibrations produced by the one or more speakers are insulated from the stylus and record. Stated another way, various embodiments in the disclosure provide an isolation attachment system between a speaker enclosure that is completely contained within a phonograph record player to provide improved sound performance and power without leading to vibrations that affect the performance of the phonograph components.

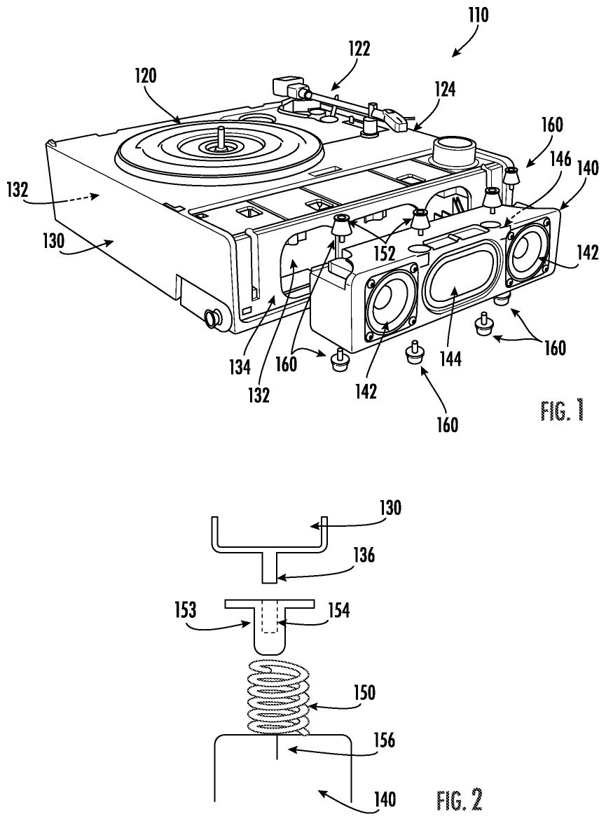

Referring to FIGS. 1-2, a phonograph record player 110 is shown according to an exemplary embodiment. Phonograph record player 110 includes a primary housing 130, secondary housing 140 coupled to primary housing 130, turntable 120, arm 122, and stylus 124. In various embodiments, primary housing 130 and/or secondary housing 140 are formed from a material including plastic (e.g., one or both are formed entirely from plastic). For example, in various embodiments a majority of primary housing 130 is formed from a first material (e.g., plastic) and/or a majority of secondary housing 140 is formed from the first material (e.g., plastic).

In various embodiments, primary housing 130 forms an enclosure that mostly and/or completely defines an internal storage volume 132 within primary housing 130, and some or all of secondary housing 140 is located within the internal storage volume 132. In various embodiments, secondary housing 140 forms an enclosure that mostly and/or completely encloses an internal storage volume 146 within secondary housing 140. Secondary housing 140 is coupled to primary housing 130, such as via one or more couplers 160, such that the primary housing 130 and the secondary housing 140 interface via the coupler(s) (e.g., via the one or more bushings and the one or more springs, such as via a bushing and a spring). In various embodiments, each coupler 160 includes a spring 150 and a bushing 152.

In various embodiments, turntable 120 is coupled to primary housing 130, such as at a top of primary housing 130, arm 122 is pivotally coupled to primary housing 130, and stylus 124 is coupled to an end of arm 122 opposite primary housing 130. Turntable 120 is configured to receive a record and rotate with respect to the primary housing 130. In use, a record is placed on turntable 120, and stylus 124 is rested within a groove in the record. When the record is rotated stylus 124 moves in response to variations within the groove thereby generating an electronic signal that represents a sound that was recorded on the record. Stated another way, stylus 124 is configured to interface with the record and generate a first electric signal representative of sound, such as sound that was recorded on the record.

One or more sound-generating devices, shown as speakers 142 and bass radiator 144, are coupled to secondary housing 140. One or more of speakers 142 and/or bass radiators 144 are partially or fully located within internal storage volume 132 of primary housing 130. In various embodiments, the sound-generating devices (e.g., speakers 142 and/or bass radiator 144) receive a second electric signal generated by stylus 124 and the sound-generating devices (e.g., speakers 142 and/or bass radiator 144) generate a sound based on that electronic signal (e.g., speakers 142 and/or bass radiator 144 play music recorded in the record). Stated another way, speaker 142 is coupled to and within the secondary housing 140, and speaker 142 is configured to receive an electric signal (e.g., from the turntable) and generate sound based on the electric signal.

In various embodiments, the electric signal generated by the stylus 124 is the same as the electric signal received by the sound-generating devices. Alternatively, the electric signal generated by the stylus is amplified and/or modified before being transmitted to the sound-generating devices (e.g., speakers 142 and/or bass radiator 144), and thus the electric signal received by the sound-generating devices is based on the electric signal generated by the stylus.

In a specific embodiment, there are two front-facing speakers 142 (e.g., speaker drivers) and a bass radiator 144, such as a passive bass radiator. In a specific embodiment, the speaker 142 is facing laterally (e.g., horizontally when the phonograph record player 110 is in use). In various embodiments, secondary housing 140 is coupled to or near a front wall 134 of primary housing 130 such that the speakers coupled to secondary housing 140 project sound through a front of primary housing 130.

As will be described, secondary housing 140 is coupled to primary housing 130 (e.g., via couplers 160) such that secondary housing 140 is vibrationally-insulated from primary housing 130. For example, secondary housing 140 is coupled to primary housing 130 such that vibrations produced by speakers 142 and/or bass radiator 144 generating sound are reduced, minimized or even prevented from being communicated from secondary housing 140 to primary housing 130.

In various embodiments, phonograph record player 110 includes a plurality of couplers 160 that couple the secondary housing 140 and the primary housing 130. The plurality of couplers 160 each include a spring and/or a bushing. In various embodiments, the plurality of couplers 160 each include a spring and a bushing. The secondary housing 140 rests on at least two couplers 160 of the plurality of couplers when the phonograph record player 110 is playing a record. In various embodiments, the secondary housing 140 rests on at least four couplers 160 of the plurality of couplers when the phonograph record player 110 is playing a record.

In various embodiments, one or more of the couplers 160 includes a bushing selected from a group consisting of a first spring, a material formed from rubber, and a material formed from a foam. Stated another way, one or more of the couplers 160 is a spring, is formed a material that includes rubber, or is formed from a material including foam.

In various embodiments, a first vibration-absorbing element, shown as spring 150, and/or a second vibration-absorbing element, shown as bushing 152, are coupled between secondary housing 140 and primary housing 130. Stated another way, in various embodiments a first bushing 152 interfaces with the primary housing 130 and the secondary housing 140 such that the primary housing 130 supports the secondary housing 140 via the first bushing 152. In various embodiments, bushing 152 is formed from a material including rubber. For example, in various embodiments the primary housing 130 is formed from a first material, and the bushing 152 is formed from a second material having a lower number on the durometer scale than the first material.

Referring to FIG. 2, in various embodiments one or more springs 150 are coupled to secondary housing 140 (e.g., rigidly coupled), such as via the one or more springs being coupled to a top or bottom of secondary housing 140 (e.g., via fastener 156). In various embodiments, bushing 153 extends into and nests within a cavity within spring 150 (e.g., within a helical profile of spring 150). Bushing 153 is functionally and/or structurally similar to bushing 152 except for the differences described herein. In particular, in various embodiments bushing 153 includes a different shape/structure than bushing 152, such as bushing 153 includes a wider base before narrowing to the projection that extends within spring 150.

Bushing 153 includes an internal cavity 154 that receives a peg and/or a projection (e.g., projection 136) protruding from primary housing 130. Once assembled, the secondary enclosure (e.g., secondary housing 140) coupled to the speakers can vibrate freely while returning to its resting position inside the main enclosure (e.g., primary housing 130) through a compression and/or friction fit provided by the spring 150 and/or bushing 153.

In various embodiments, springs 150 are formed from a material including metal. In various embodiments, springs form a helical shape that compress and/or extend in response to external forces. The compression and/or the extension of springs 150 thereby reduces vibration being communicated from secondary housing 140 to primary housing 130.

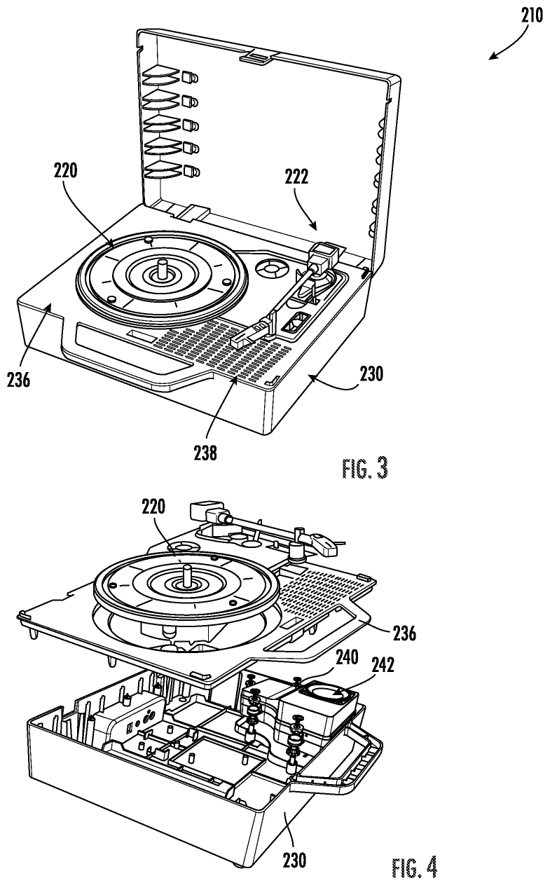

Referring to FIGS. 3-7, phonograph record player 210 is shown according to an exemplary embodiment. Phonograph record player 210 is substantially the same as phonograph record player 110 except for the differences discussed herein.

As shown in the images, in various embodiments phonograph record player 210 isolates the speaker drivers in a phonograph record player from the main enclosure itself to reduce, minimize and/or prevent vibrations from being communicated from speakers to the tonearm and/or the record. In various embodiments, phonograph record player 210 includes turntable 220, arm 222, primary housing 230, support plate 236 and upper apertures 238. Turntable 220 and/or arm 222 are coupled to primary housing 230, such as via turntable 220 and/or arm 222 being coupled to support plate 236, which is coupled to primary housing 230. Stated another way, in various embodiments support plate 236 is coupled to the primary housing 240, support plate 236 supports the turntable 220, and support plate 236 includes a plurality of apertures 238 through which the speaker projects sound.

In various embodiments, primary housing 230 forms an enclosure that mostly and/or completely encloses an internal area within primary housing 230. In various embodiments, secondary housing 240 forms an enclosure that mostly and/or completely encloses an internal area within secondary housing 240.

A secondary housing 240 is coupled to primary housing 230 such that vibrations from secondary housing 240 to primary housing 230 are reduced, minimized and/or prevented from being communicated. One or more sound-generating devices, such as speakers 242, are coupled to secondary housing 240. In various embodiments, one of speakers 242 projects sound through upper apertures 238. In various embodiments, one or more alternate sound-generating devices, such as subwoofer 244, are coupled to secondary housing 240. Subwoofer 244 projects sound through lower apertures 232 within primary housing 230.

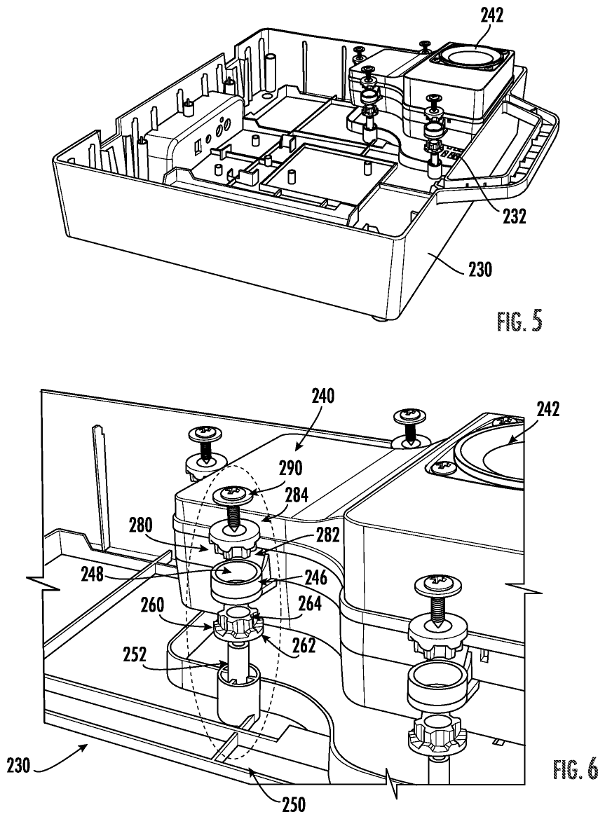

In various embodiments, secondary housing 240 is coupled to primary housing 230 via one or more coupling mechanisms 250. In various embodiments, coupling mechanisms vibrationally-insulate secondary housing 240 from primary housing 230, and thus coupling mechanisms 250 insulate vibrations generated by secondary housing 240 (e.g., generated by speakers) from being communicated from secondary housing 240 to turntable 220 and/or arm 222. Stated another way, in various embodiments secondary housing 240 is placed inside primary housing 230 so that in its final position the material of the secondary housing 240 is never in direct contact with the primary housing 230 except through the vibration absorbing system shown in FIGS. 5-7.

In various embodiments, the phonograph record player 210 includes a plurality of lower bushings (e.g., bushings 260), and the plurality of lower bushings (e.g., bushings 260) interface with the primary housing 230 and the secondary housing 240 such that the primary housing 230 supports the secondary housing 240 via the plurality of lower bushings (e.g., bushings 260), such as when phonograph record player 210 is playing a record. In various embodiments, the plurality of lower bushings are arranged around a periphery of the secondary housing 240 (e.g., around at least three of the four sides of secondary housing 240).

In various embodiments, coupling mechanism 250 includes projection 252 (e.g., raised fastener bosses) extending from and/or coupled to primary housing 230. Bushing 260 is coupled to projection 252, projection 246 (e.g., a cylindrical attachment ring) extends from secondary housing 240 (e.g., laterally from secondary housing 240) and is coupled to bushing 260, bushing 280 is coupled to projection 246, and fastener 290 (e.g., a screw) couples bushing 280 to primary housing 230. Stated another way, fastener 290 couples secondary housing 240 to primary housing 230, and bushing 280 interfaces with fastener 290 and secondary housing 240 (e.g., bushing 280 is between fastener 290 and secondary housing 240) such that the fastener 290 is vibrationally-insulated from the secondary housing 240 via the second bushing 280.

In various embodiments projections 246 (e.g., cylindrical attachment rings) are lowered until the rings are resting on the wider cylinder of bushings 260. In this way, in various embodiments the rings of the secondary housing 240 do not come in contact with primary housing 230 except through the bushing 260.

In various embodiments, bushing 260 and/or bushing 280 are formed from a vibration-absorbing material, such as rubber. In various embodiments, bushing 260 and bushing 280 are vibration dampening components that vibrationally-separate the secondary housing 240 from the primary housing 230. One or more of bushing 260 and/or bushing 280 is built with a soft, shock and vibration absorbing material such as rubber, silicone, or other soft materials, such as soft synthetic materials.

Bushing 260 includes a wider portion 262 that couples to projection 252 (e.g., via wider portion 262 circumferentially extending around projection 252). Projection 246 defines an internal opening 248 that couples to bushing 260 and/or bushing 280, such as via projection 246 circumferentially extending around narrower portion 264 of the respective bushing 260 such that internal opening 248 receives at least a portion of the respective bushing.

In various embodiments, wider portion 262 of bushing 260 defines an outermost radius that is further than an outermost radius of narrower portion 264. Stated another way, one bushing 260 is placed on one of the projections 252 in a vertical orientation so that the wider cylinder of bushing 260 is towards the bottom of primary housing 230 and the smaller cylinder of bushing 260 is towards the top of the projection 252.

Bushing 280 includes a narrower portion 282 that couples to projection 246 (e.g., via projection 246 circumferentially extending around narrower portion 282). In various embodiments, wider portion 284 of bushing 280 defines an outermost radius that is further than an outermost radius of narrower portion 282, and as a result wider portion 284 rests on top of projection 246.

Stated another way, bushing 280 is then placed in the opposite orientation of the previous bushing (e.g., bushing 260) with the smaller cylinder of bushing 280 facing towards the smaller cylinder of bushing 260. A fastener (e.g., fastener 290) is then installed through the wider cylinder of bushing 280 directly into the projection 252 of the primary housing 230. In this way, in various embodiments primary housing 230 and secondary housing 240 never come in direct contact except through the bushing material used for bushing 260 and bushing 280. This includes reduced, minimal, or no direct contact from primary housing 230 and secondary housing 240 and reduced, minimal, or no contact through the fastener 290 that could also lead to vibrations transferring from secondary housing 240 to primary housing 230.

In various embodiments, fastener 290 is formed from a first material (e.g., metal or a plastic), and the second bushing 280 is formed from a second material (e.g., rubber) having a lower number on the durometer scale than the first material. In various embodiments, second bushing 280 is formed from a material selected from a group consisting of rubber and foam.

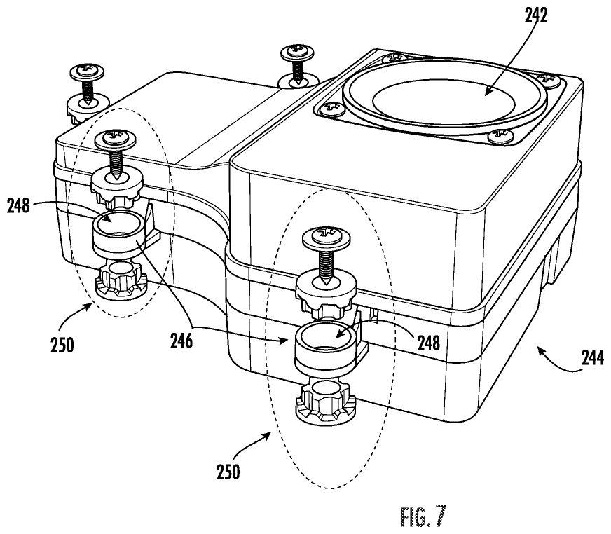

Referring to FIG. 7, in various embodiments secondary housing 240 is coupled to primary housing 230 via a plurality of coupling mechanisms 250. In a specific embodiment, secondary housing 240 is coupled to primary housing 230 via five coupling mechanisms 250.

In various embodiments, secondary housing 240 is nested within primary housing 230. In a specific embodiment, secondary housing 240 is formed from plastic and forms a sealed plastic enclosure including one or more sound-generating devices, such as one or more speakers 242 (e.g., one speaker) and one or more subwoofers 244 (e.g., one subwoofer).

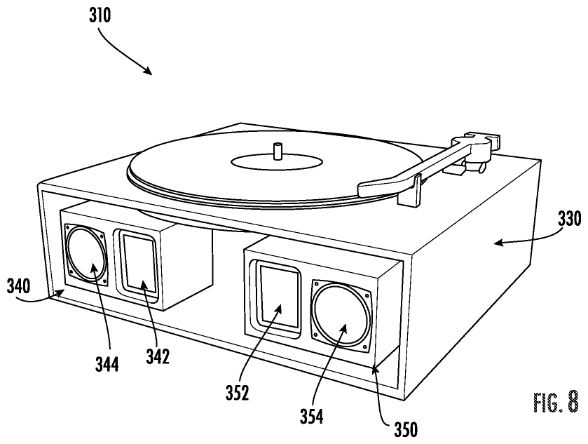

Referring to FIG. 8, phonograph record player 310 is shown according to an exemplary embodiment. Phonograph record player 310 is substantially the same as phonograph record player 110 or phonograph record player 110 except for the differences discussed herein.

In various embodiments, phonograph record player 310 includes a plurality of secondary housings (e.g., two separate speaker enclosures, such as secondary housing 340 and secondary housing 350) inside the same primary housing 330. In various embodiments, the secondary housings include different or the same combinations of sound-producing devices. For example, as shown secondary housing 340 includes speaker 342 and speaker 344, which each produce sounds at varying ranges, and secondary housing 350 speaker 352 and speaker 354, which each produce sounds at varying ranges of sound.

In various embodiments, one or more of primary housing 330 and the secondary housing or secondary housings are formed from wood. In various embodiments the secondary housing 340 or secondary housings 340, 350 are coupled to primary housing 330 via springs, rubber bushings, and/or foam, such as thick foam. In various embodiments, different secondary housings are coupled to the primary housing 230 via different coupling mechanisms (e.g., one front-firing speaker with rubber bushings and one or more top-firing speakers with springs).

In a specific embodiment, phonograph record player 310 includes a primary housing formed from a first material, a first secondary housing that includes a speaker, a first bushing that interfaces with the primary housing and the first secondary housing such that the primary housing supports the first secondary housing via the first bushing, a second secondary housing that includes a second speaker, and a second bushing that interfaces with the primary housing and the second secondary housing such that the primary housing supports the second secondary housing via the second bushing.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A phonograph record player comprising:
a primary housing formed from a first material;
a turntable coupled to the primary housing, the turntable configured to receive a record and rotate with respect to the primary housing;
a stylus configured to interface with the record and generate a first electric signal representative of sound;
a spring;
a bushing formed from a second material having a lower number on the durometer scale than the first material;
a secondary housing coupled to the primary housing such that the primary housing and the secondary housing interface via the bushing and the spring; and
a speaker coupled to and within the secondary housing, the speaker configured to receive a second electric signal and generate sound based on the second electric signal.

2. The phonograph record player of claim 1, wherein the second electric signal is the first electric signal.

3. The phonograph record player of claim 1, the primary housing defining an internal storage volume, wherein the speaker is at least partially located within the internal storage volume.

4. The phonograph record player of claim 1, wherein the bushing extends within the spring.

5. The phonograph record player of claim 4, the bushing defining an internal cavity receiving a projection extending from the primary housing.

6. The phonograph record player of claim 1, wherein the bushing extends within a helical profile of the spring.

7. The phonograph record player of claim 6, wherein the spring is rigidly coupled to the secondary housing.

8. The phonograph record player of claim 6, wherein the bushing is formed from a material comprising rubber.

9. The phonograph record player of claim 1, the spring comprising a first spring and the bushing comprising a first bushing, the phonograph record player comprising:
a plurality of couplers that couple the secondary housing and the primary housing, the plurality of couplers each comprising a spring and a bushing, wherein a first coupler of the plurality of couplers comprises the first spring and the first bushing, and wherein the secondary housing rests on at least four couplers of the plurality of couplers when the phonograph record player is playing a record.

10. A phonograph record player comprising:
a primary housing defining an internal storage volume;
a turntable coupled to the primary housing, the turntable configured to receive a record and rotate with respect to the primary housing;
a stylus configured to interface with the record and generate a first electric signal representative of sound;
a secondary housing coupled to the primary housing within the internal storage volume;
a speaker coupled to and within the secondary housing, the speaker configured to receive an electric signal and generate sound based on the electric signal; and
a first bushing that interfaces with the primary housing and the secondary housing such that the primary housing supports the secondary housing via the first bushing, wherein the first bushing is selected from a group consisting of a first spring, a material formed from rubber, and a material formed from a foam.

11. The phonograph record player of claim 10, comprising:
a fastener coupling the secondary housing to the primary housing; and
a second bushing that interfaces with the fastener and the secondary housing such that the fastener is vibrationally-insulated from the secondary housing via the second bushing.

12. The phonograph record player of claim 11, comprising a projection that extends laterally from the secondary housing, the projection defining an internal opening that receives the second bushing.

13. The phonograph record player of claim 11, wherein the fastener is formed from a first material, and wherein the second bushing is formed from a second material having a lower number on the durometer scale than the first material.

14. The phonograph record player of claim 11, wherein the second bushing is formed from a material selected from a group consisting of rubber and foam.

15. The phonograph record player of claim 14, comprising a projection that extends laterally from the secondary housing, the projection defining an internal opening that receives the second bushing.

16. The phonograph record player of claim 10, comprising:
a plurality of lower bushings including the first bushing, the plurality of lower bushings interfacing with the primary housing and the secondary housing such that the primary housing supports the secondary housing via the plurality of lower bushings.

17. The phonograph record player of claim 16, wherein the plurality of lower bushings are arranged around a periphery of the secondary housing.

18. The phonograph record player of claim 10, the primary housing defining an internal storage volume, wherein the speaker is at least partially located within the internal storage volume.

19. The phonograph record player of claim 10, comprising:
a support plate coupled to the primary housing, the support plate supporting the turntable, the support plate comprising a plurality of apertures through which the speaker projects the sound.

20. A phonograph record player comprising:
a primary housing formed from a first material;
a turntable coupled to the primary housing, the turntable configured to receive a record and rotate with respect to the primary housing;
a stylus configured to interface with the record and generate a first electric signal representative of sound;
a first secondary housing;
a first speaker coupled to and within the first secondary housing, the first speaker configured to receive an electric signal and generate sound based on the electric signal;
a first bushing that interfaces with the primary housing and the first secondary housing such that the primary housing supports the first secondary housing via the first bushing;
a second secondary housing;
a second speaker coupled to and within the second secondary housing, the second speaker configured to receive an electric signal and generate sound based on the electric signal; and
a second bushing that interfaces with the primary housing and the second secondary housing such that the primary housing supports the second secondary housing via the second bushing.
